(19) United States
(12) Patent Application Publication
(10) Pub. No.: US 2002/0057488 A1
(43) Pub. Date: May 16, 2002

(54) Wavelength selector and converter device and a photonic switching matrix incorporating it

(75) Inventors: Dominique Chiaroni, Antony (FR); Nicolas Le Sauze, Bures-Sur-Yvette (FR); Alain Pons, Ollainville (FR); Amaury Jourdan, Sevres (FR)

Correspondence Address: SUGHRUE, MION, ZINN, MACPEAK & SEAS, PLLC, Suite 800, 2100 Pennsylvania Avenue, N.W., Washington, DC, 20037-3213, US

(73) Assignee: ALCATEL

(21) Appl. No.: 09/985,258

(22) Filed: Nov. 2, 2001

(30) Foreign Application Priority Data
Nov. 13, 2000 (FR) 00 14 531

(51) Int. Cl. G02F 1/35; H04J 14/02

(52) U.S. Cl. 359/326; 359/128

(57) ABSTRACT

A wavelength selector and converter device for n spectral components of a wavelength division multiplexed input signal, the n spectral components being identified by n respective input carrier wavelengths, includes a demultiplexer and broadcaster arrangement for sampling from the input signal p parts of each spectral component and thereby forming n.p spatially separated extracted signals. p wavelength converter devices associated with each spectral component receive p respective signals extracted from the associated spectral component and supply p converted signals as a function of the p respective extracted signals. The p converted signals are conveyed by p respective different predetermined output wavelengths. Each converter device has an optical gate function. An output coupler arrangement couples the outputs of the wavelength converter devices to a common output port.

### CROSS-REFERENCE TO RELATED APPLICATIONS

This application is based on French Patent Application No. 00 14 531 filed Nov. 13, 2000, the disclosure of which is hereby incorporated by reference thereto in its entirety, and the priority of which is hereby claimed under 35 U.S.C. §119.

### BACKGROUND OF THE INVENTION

1. Field of the Invention

The invention relates to optical transmission networks and more precisely to switching devices for wavelength division multiplexed optical signals organized into packets.

2. Description of the Prior Art

Generally speaking, optical packet switching networks include nodes provided with fast packet switching devices for routing variable or fixed size groups of data, usually called “packets” in the case of a network using an Internet protocol or “cells” in the case of an ATM network.

Photonic switching matrices are “all-optical” switching devices in which data, generally in the form of amplitude modulation of an optical carrier wave, is routed from one optical link to another preserving its optical nature, i.e. without conversion into the electrical domain. One function of these matrices is packet synchronization, with a view to managing conflicts to minimize packet losses. If wavelength division multiplexing (WDM) is used, the matrices must also take account of the spectral dimension of the signals to be switched.

The invention relates to a wavelength selector and converter device that can be used to manage wavelength division multiplexing in photonic switching matrices.

The invention also relates to a photonic switching matrix incorporating the device.

FIG. 1 shows one example of an optical switch to which the invention can be applied.

The switch essentially consists of a photonic switching matrix 1 and an associated electronic control unit 2.

In the general case, the matrix 1 has a plurality of inputs and a plurality of outputs, for example 16 inputs and 16 outputs. However, for reasons of clarity, only two inputs Q, Q′ and two outputs R, R′ are shown. The inputs Q, Q′ receive WDM optical input signals We, We′ and the outputs R, R′ supply WDM optical output signals Ws, Ws′. The signals We, We′ each consist of a plurality of spectral components that can be conveyed by n respective input lengths λ1-λn allocated to n spectral channels. Likewise, the signals Ws, Ws′ consist of spectral components that can be conveyed by p respective output wavelengths λ1-λ′p. Generally speaking, all these wavelengths are part of the same set of spectral resources and p=n.

Because the matrix generally has the same number of inputs and outputs, it can be organized into modules, such as the modules 3, 3′, each associated with one input and one output.

Thus the signals We, We′ are coupled to the respective modules 3, 3′ via variable delay lines DL, DL′ and to respective optical-electrical conversion interfaces OE, OE′ of the control unit 2 via demultiplexers De, De′.

The switching matrix 1 includes sets of delay lines 5 coupled in cascade and each belonging to one of the modules 3, 3′, a common crossbar space switch 6, spectral selector stages 7, spectral reallocator stages 8, and output coupler stages 4 each belonging to one of the modules.

The electronic control unit 2 includes a processor 9 connected to the outputs of the optical-electrical conversion interfaces OE, OE′ and to a control circuit 10.

A first function of the processor 9 is decoding the various headers of the received packets to extract therefrom the respective destinations. The processor 9 then manages any conflicts as a function of the destination information generated by choices imposed by a routing table. Thus for each received packet conveyed by each wavelength, the processor 9 determines to which output port of the matrix and at what time the packet must be directed. This routing information is transmitted to the control circuit 10 which then sends appropriate control signals to the space switch 6 and to the spectral selector stages 7.

FIG. 2 shows one of the modules 3 of the prior art matrix 1 in more detail. The set 5 of delay lines essentially consists of q delay lines L1, Lu, Lq of different lengths, each of which is adapted to create a time-delay that is an integer multiple of the packet transmission time. Each delay line receives the input multiplex We associated with the module via a broadcast coupler 11.

The outputs of the q delay lines are coupled to q respective inputs of the common space switch 6.

The spectral selector stage 7 comprises p wavelength selectors SEL1, SEL2, SELj, SELp controlled by respective control signals CC1, CC2, CCj, CCp from the control circuit 10.

The inputs of the p selectors are coupled to p respective outputs of the space switch 6 supplying the signals S1, S2, Sj, Sp. The selectors SEL1, SEL2, SELj, SELp are connected to p respective wavelength converters Cλ1, Cλ2, Cλj, Cλp constituting the spectral reallocator stage 8. The converters supply at their outputs signals S′1, S′2, S′j, S′p which are applied to corresponding inputs of the output coupler stage 4.

The spectral selector stage 7 and the spectral reallocator stage 8 therefore take account of the spectral dimension of the signals. Accordingly, each signal Sj from an output of the switch 6 is processed by a wavelength selector and converter device SELJ, Cλj of one of the modules 3 before it is injected into the output coupler stage 4 of that module.

Accordingly, and as a function of the state of the space switch 6 and the wavelengths selected by the various selectors, each packet belonging to any input multiplex and conveyed by any wavelength can, after an appropriate time-delay, be routed to an output of the matrix and be conveyed at the output by a new wavelength.

The selection function implemented by each selector SELj consists of extracting from the WDN signal Sj received from the switch 6 a signal conveyed by only one of the wavelengths assigned to the spectral channels of the WDM signal. The wavelength converters Cλ1-Cλp of the same module 3 have the function of having the signals extracted in this way conveyed by new, fixed and different wavelengths λ′1-λ′p so that they can be combined again by the coupler stage 4 to constitute the output WDM signal Ws. The coupler stage 4 can consist of a multiplexer whose inputs are set to respective wavelengths imposed by the wavelength converters.

FIG. 3 shows a prior art wavelength selector and converter device SELj, Cλj associated with one output of the switch 6.

The selector device SELj includes an input broadcast coupler Cej with one input and n outputs coupled to n respective inputs of a multiplexer MX via n optical gates OG1, OG2, OGx, OGn controlled electrically by the signals CCj. The output of the multiplexer MX is coupled to the input of the wavelength converter Cλj.

In operation, the input coupler Cej receives the WDM signal Sj and the optical gates receive control signals CCj such that only one of the gates is open, for example the gate OGx. Thus only the input of the multiplexer MX that is coupled to the gate OGx receives the signal Sj and, because of the filter function of the multiplexers, only the wavelength to which that input is set, for example the wavelength λx, is transmitted to the output of the multiplexer MX. The multiplexer then supplies to the converter Cλj a signal sx which belongs to the spectral channel at the wavelength λx. As a function of the signal sx selectively extracted in this way, the converter Cλj delivers the converted signal S′j conveyed by the wavelength λ′j imposed by that converter.

As already indicated, during each packet period and by means of a chosen delay line, for example the line Lu, the matrix described hereinabove couples a given input multiplex, for example the multiplex We, to one input of a spectral selector stage 7 associated with one of the outputs R of the matrix. It is therefore possible to transfer to any chosen output a chosen packet belonging to a chosen spectral channel of a chosen input multiplex. Nevertheless, this embodiment cannot transfer to the same output during the same packet period a plurality of packets that are synchronized at the input and belong to the same input multiplex.

This implies that a switch in accordance with this architecture is unable to offer optimum performance either in terms of packet loss or in terms of packet transfer time-delay.

An object of the invention is to remedy this drawback by proposing a wavelength selector and converter device enabling transfer to the same output of a plurality of packets that are synchronized at the input, belong to the same input multiplex, and are subject to the same time-delay.

### SUMMARY OF THE INVENTION

To this end, the invention proposes a wavelength selector and converter device for n spectral components of a wavelength division multiplexed input signal, the n spectral components being identified by n respective input carrier wavelengths, which device includes:

demultiplexer and broadcaster means for sampling from the input signal p parts of each spectral component and thereby forming n.p spatially separated extracted signals,

associated with each spectral component, p wavelength converter devices receiving p respective signals extracted from the associated spectral component and adapted to supply p converted signals as a function of the p respective extracted signals, the p converted signals being conveyed by p respective different predetermined output wavelengths, each converter device having an optical gate function, and

output coupler means adapted to couple the outputs of the wavelength converter devices to a common output port.

Thanks to this arrangement, the signal from the device can be a wavelength division multiplex including synchronous packets conveying data from synchronous packets of the same WDM signal at the matrix input.

The invention also provides various embodiments of the demultiplexer and broadcaster means and the output coupler means.

A first embodiment of the demultiplexer and broadcaster means includes:

an input coupler adapted to supply on p outputs p parts of the input signal, and

p input demultiplexers each having an input and n outputs, the inputs of the input demultiplexers being coupled to respective outputs of the input coupler, and each of the input demultiplexers being adapted to supply at its outputs n signals extracted from the n respective spectral components.

A different embodiment of the demultiplexer and broadcaster means includes:

an input demultiplexer adapted to supply at n outputs the n spectral components of the input signal, and

n input couplers each having an input and p outputs, the inputs of the input couplers being coupled to respective outputs of the input demultiplexer.

A first embodiment of the output coupler means includes:

p output couplers associated with the respective output wavelengths and each having an output and n inputs adapted to receive respective converted signals conveyed by the associated output wavelength, and

an output multiplexer having an output and p inputs set to the p respective output wavelengths and coupled to respective outputs of respective output couplers associated with the output wavelengths.

A first embodiment of the output coupler means includes:

n output multiplexers each having an output an p inputs set to the p respective output wavelengths and adapted to receive respective converted signals conveyed by the respective output wavelengths, and

an output coupler having an output and n inputs coupled to respective outputs of the output multiplexers.

The choice of the demultiplexer and broadcaster means and the output coupler means from among those indicated above impacts on the properties of the device in relation to the following aspects:

fabrication cost, depending on the complexity and the number of components;

the possibility of amplifying the converted signals; and

the possibility of integrating the system.

In another embodiment of the invention each wavelength converter device includes a semiconductor optical amplifier used as an optical gate and receiving one of the extracted signals and a probe wave having one of the particular wavelengths, a converted signal consisting of the probe wave amplified by the amplifier with a gain that is a function of the optical power of the extracted signal that it receives.

The advantage of this embodiment is that a single component, the semiconductor optical amplifier, serves both as an optical gate and as a wavelength converter.

Each amplifier advantageously has a maximum gain at the wavelength of the extracted signal it receives.

The invention also provides a photonic switching matrix including the device according to the invention.

Other aspects and advantages of the invention will become apparent in the remainder of the description with reference to the figures.

### BRIEF DESCRIPTION OF THE DRAWINGS

FIG. 1 shows one example of an optical switch, already commented on.

FIG. 2 shows one module of a photonic switching matrix, also already commented on.

FIG. 3 shows a prior art wavelength selector and converter device, also already commented on.

FIG. 4 is a block diagram of a wavelength selector and converter device according to the invention.

FIG. 5 shows a first embodiment of a device according to the invention.

FIG. 6 shows a second embodiment of a device according to the invention.

FIG. 7 shows a third embodiment of a device according to the invention.

FIGS. 8 and 9 show embodiments of wavelength converter devices used to implement the invention.

### DETAILED DESCRIPTION OF THE PREFERRED EMBODIMENTS

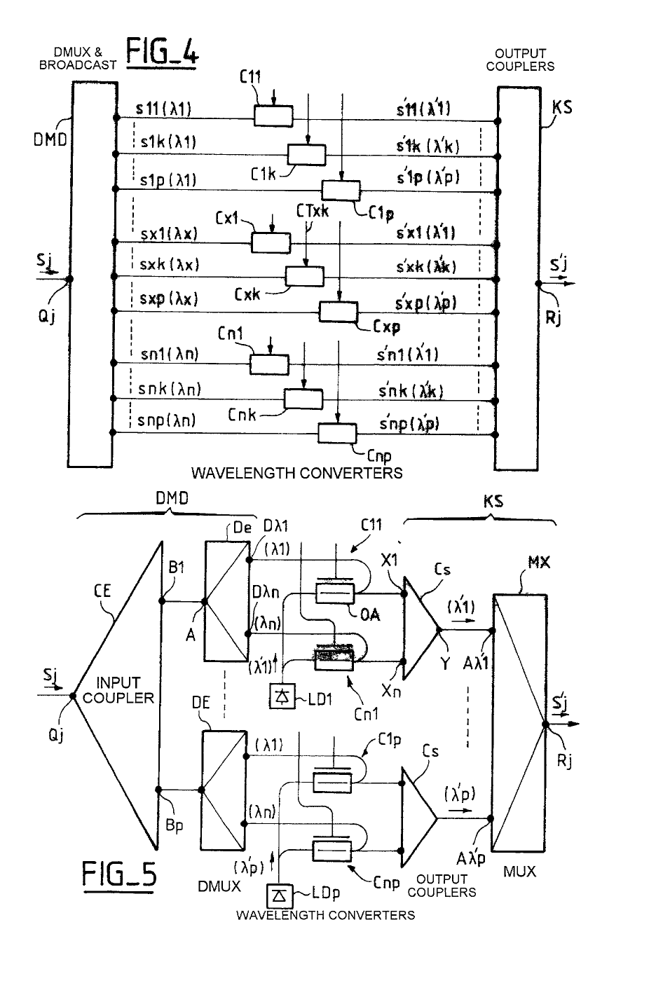

The wavelength selector and converter device shown in the FIG. 4 block diagram receives a WDM input signal Sj including n spectral components identified by n respective input carrier wavelengths λ1, . . . λx, . . . λn. The device supplies a WDM output signal S′j including at most p spectral components identified by p respective output carrier wavelengths λ′1, . . . λ′k, . . . λ′p.

The device includes demultiplexer and broadcaster means DMD which have an input port Qj receiving the signal Sj and n.p outputs coupled to n.p respective inputs of output coupler means KS by n.p wavelength converters C11-Cnp. The output port Rj of the output coupler means KS delivers the output signal S′j.

The demultiplexer and broadcaster means DMD extract from the signal Sj n.p signals S11-snp defined as follows. For each input wavelength, for example the wavelength λx, the demultiplexer and broadcaster means DMD supply the signals sx1, . . . , sxk, . . . , sxp which consist of p respective parts of the spectral component of the signal Sj conveyed by the input carrier wavelength λx.

Each extracted signal, for example the signal sxk, is applied to the input of a corresponding wavelength converter Cxk adapted to supply a converted signal s′xk which is a function of the signal sxk and is conveyed by an output wavelength λ′k. For the same input wavelength, for example the wavelength λx, there are p converter devices Cx1, . . . Cxk, . . . Cxp adapted to supply p converted signals s′x1, . . . s′xk, . . . s′xp conveyed by p respective different output wavelengths λ′1, . . . ,λ′k, . . . λ′p.

Each wavelength converter, for example the converter Cxk, also has an optical gate function controlled by an associated control signal CTxk.

In operation, the control signals (symbolized by arrows with no reference numbers) applied to the converters are such that at most one of the converters receiving the signals extracted from the same spectral component is active. For example, to convert the input wavelength λx to the wavelength λ′k, of the converters Cx1, . . . Cxk, . . . Cxp receiving the signals sx1, . . . , sxk, . . . , sxp, only the converter Cxk is activated by the control signal CTxk.

At most p converted signals from a total of s′11-s′np signals supplied by the converters selectively activated in this way are then combined by the output coupler means KS.

In practice, all of the input and output wavelengths λ1-λn and λ′1-λ′p generally form part of a common set of spectral resources allocated to the network, but it is not necessary for them to be identical or for n to be equal to p.

FIGS. 8 and 9 shows two embodiments of the wavelength converters. Each converter shown in the figures, such as the converter Cxk, is based on a semiconductor optical amplifier OA used both as an optical gate and as a wavelength converter.

In a manner that is known to the person skilled in the art, the amplifier OA is used under crossed gain modulation conditions. It receives the signal to be converted and a probe wave supplied by a laser source. It then delivers a converted signal conveyed by the wavelength of the probe wave modulated oppositely to the modulation of the signal to be converted. Thus the converter Cxk, for example, receives the extracted signal sxk and the probe wave Pλ′k at the wavelength λ′k and supplies at its output the corresponding converted signal s′xk conveyed by the wavelength λ′k.

The probe wave Pλ′k and the extracted signal sxk injected into the amplifier OA propagate in opposite directions here. Although this is not indispensable, it limits filtering constraints in the output coupler means KS.

In the FIG. 8 embodiment, the optical gate function of the amplifier OA is obtained by modifying its power supply voltage.

In the FIG. 9 embodiment, the probe wave Pλ′k is injected into the amplifier OA via an optical gate OGxk. The optical gate function of the amplifier OA is then obtained by modifying the control voltage of the gate.

In this embodiment, the amplifiers OA (not shown) of the converters C1k, . . . Cxk, . . . Cnk for supplying converted signals conveyed by the same wavelength λ′k are coupled to a common laser source LDk by respective optical gates OG1k, . . . OGxk, . . . OGnk, of which only one at most is selectively activated.

By spatially separating the electrical control functions and optical functions, this embodiment has the advantage that it facilitates integrating the optical parts of several devices to produce a complete integrated matrix.

To optimize the implementation, each amplifier has a maximum gain at the wavelength of the extracted signal that it receives. This can be achieved, in a manner that is well known to optical component manufacturers, by an appropriate choice of the composition of the active layer and the geometry of each amplifier.

FIG. 5 shows a first embodiment of a device according to the invention.

In this embodiment, the demultiplexer and broadcaster means DMD include:

an input coupler CE adapted to supply on p outputs B1-Bp p parts of the input signal Sj, and

p input demultiplexers De each having an input A and n outputs Dλ1-Dλn, the inputs of the input demultiplexers De being coupled to respective outputs B1-Bp of the input coupler CE, and each of the input demultiplexers De being adapted to supply at its outputs Dλ1-Dλn n signals s1k-snk extracted from n respective spectral components λ1-λn.

Furthermore, the output coupler means KS include:

p output couplers Cs associated with respective output wavelengths λ′1-λ′p and each having an output Y and n inputs X1-Xn disposed to receive respective converted signals s′1k-s′nk conveyed by the associated output wavelength λ′k, and

an output multiplexer MX having an output Rj and p inputs Aλ′1-Aλ′p set to p respective output wavelengths λ′1-λ′p and coupled to Y respective outputs of the output couplers Cs associated with respective output wavelengths λ′1-λ′p.

The n outputs Dλ1-Dλn of each input demultiplexer De are coupled to n respective inputs X1-Xn of the one of the outputs couplers Cs via wavelength converters. Here they are based on semiconductor optical amplifiers OA each receiving from one of the laser sources LD1-LDp a probe wave having the wavelength λ′1-λ′p associated with the input demultiplexer.

If the converted signals must be amplified, this solution has the advantage of being most suitable for integrated implementation, whilst enabling amplification at reduced cost. The outputs of each demultiplexer are coupled to wavelength converters adapted to supply converted signals having the same wavelength, and the converted signals are received by the same output coupler Cs. Accordingly, any signal delivered by the output Y of each output coupler Cs always has the same wavelength. It is therefore possible to place downstream of each output coupler Cs a simple narrow-band amplifier centered on the associated wavelength. As the topology of the connecting guide between the components of the guide is simple, integrating the system is facilitated.

Furthermore, the use of an output multiplexer MX instead of a simple coupler reduces noise at the output generated by the amplifiers.

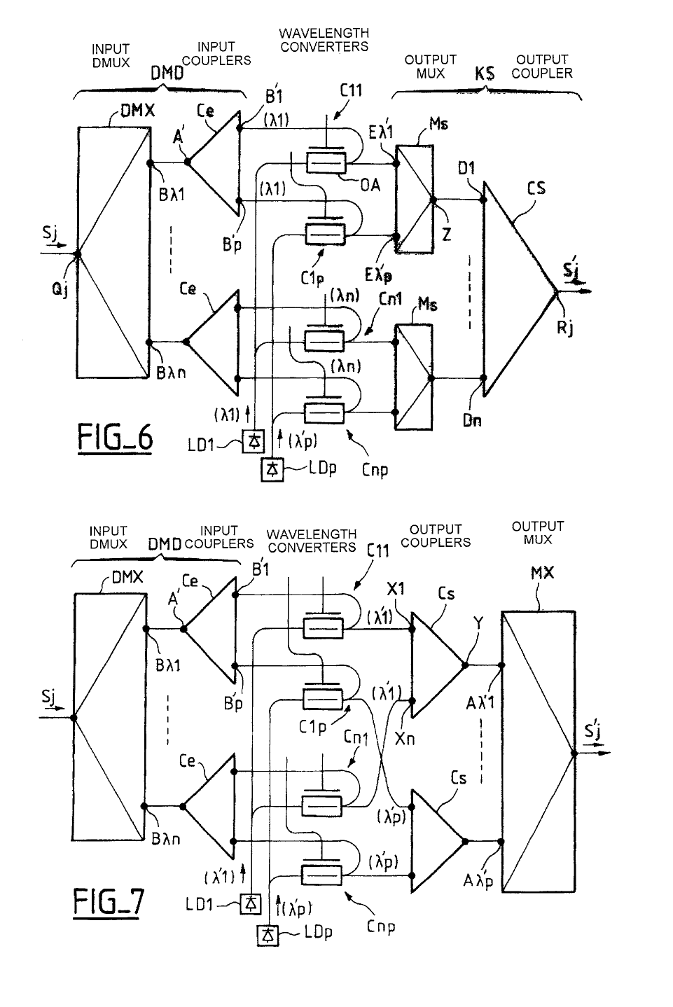

FIG. 6 shows a different embodiment of a device according to the invention.

In this embodiment, the demultiplexer and broadcaster means DMD include:

an input demultiplexer DMX adapted to supply on n outputs Bλ1-Bλn the n spectral components λ1-λn of the input signal Sj, and

n input couplers Ce each having an input A′ and p outputs B′1-B′p, the inputs of the input couplers being coupled to respective outputs Bλ1-Bλn of the input demultiplexer DMX.

Moreover, the output coupler means KS include:

n output multiplexers Ms each having an output Z and p inputs Eλ′1-Eλ′p tuned to p respective output wavelengths λ′1-λ′p and disposed to receive respective converted signal s′x1-s′xp conveyed by the respective output wavelengths λ′1-λ′p and

an output coupler CS having an output Rj and n inputs D1-Dn coupled to Z respective outputs of the output multiplexers Ms.

The p outputs B′1-B′p of each input coupler Ce are coupled to the p respective inputs Eλ′1-Eλ′p of one output multiplexer Ms via wavelength converters. They are based on semiconductor optical amplifiers OA receiving from respective laser sources LD1-LDp probe waves having the respective wavelengths λ′1-λ′p.

Compared to the first solution, this alternative requires only a single 1-to-n demultiplexer, but it is less favorable in terms of providing economic amplification because it is necessary to provide wider band amplifiers at the output of the output multiplexers Ms to cover all of the wavelengths λ′1-λ′p.

FIG. 7 shows another embodiment. The demultiplexer and broadcaster means DMD are identical to those of FIG. 6 and the output coupler means KS are identical to those of FIG. 5.

The p outputs B′1-B′p of each input coupler Ce are coupled to respective inputs of different output couplers Cs via wavelength converters chosen so that each output coupler Cs can receive only converted signals carried by the same associated output wavelength.

This solution has the advantage of necessitating only one input demultiplexer DMX and one output demultiplexer MX. Also, it is favorable in terms of providing economic amplification of the converted signals. On the other hand, it is suitable only for hybrid implementation using fibers to interconnect the output couplers and the converters.

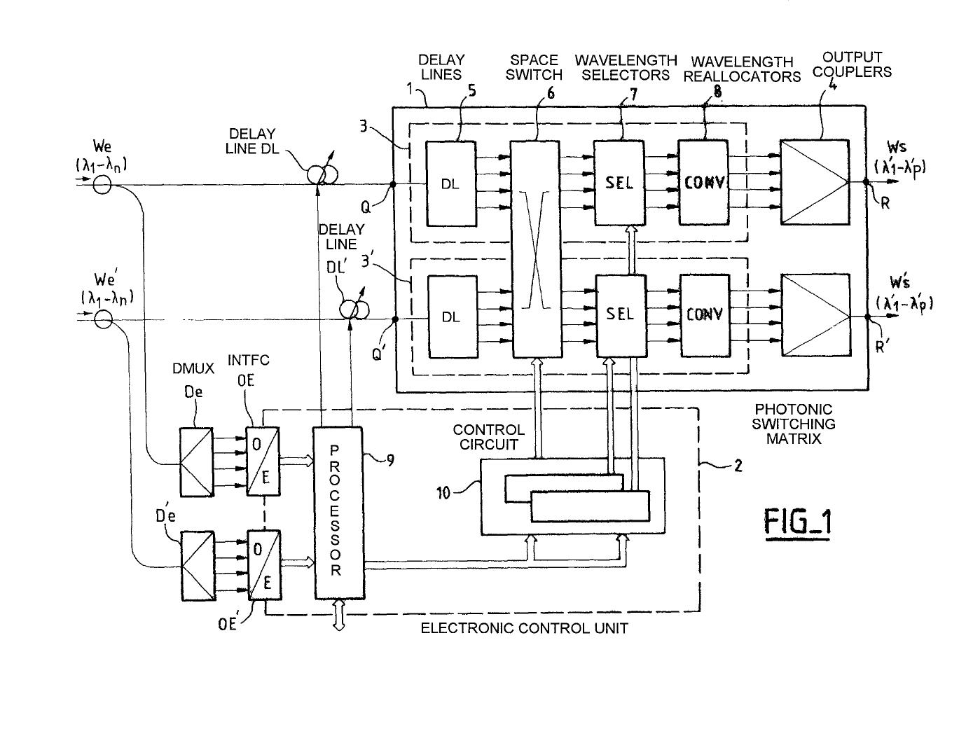

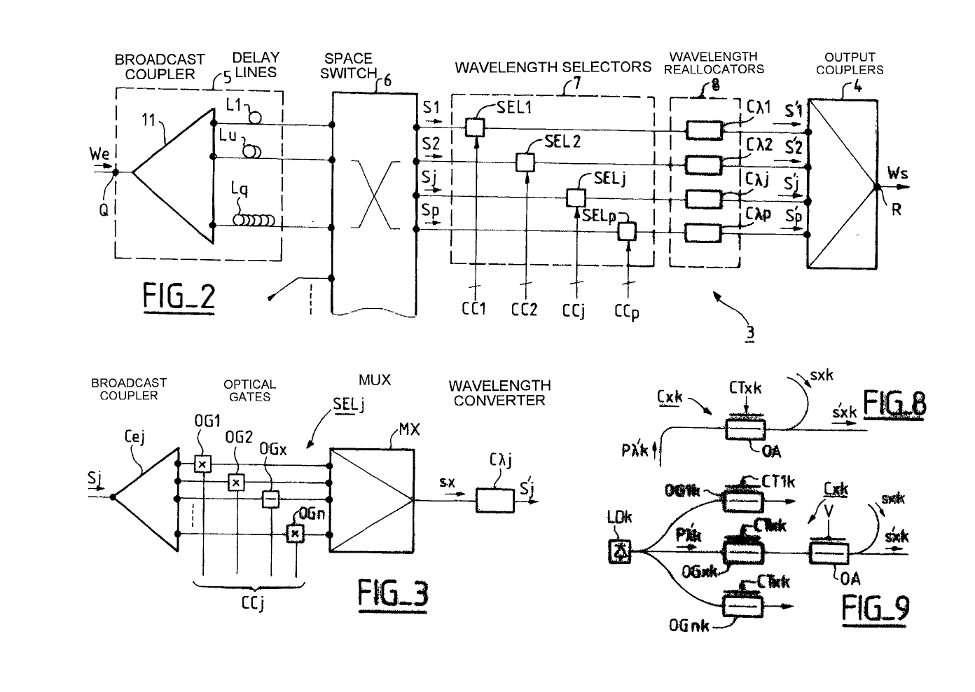

As already described with reference to FIGS. 1 and 2, the photonic switching matrix 1 according to the invention includes one or more sets 5 of delay lines, a space switch 6, one or more spectral selector stages 7 and one or more spectral reallocator stages 8. In accordance with the invention, the spectral selector stages 7 and the spectral reallocator stages 8 include wavelength selector and converter devices as described with reference to FIGS. 4 to 7.

It should be noted that the output coupler stages 4 previously described with reference to FIG. 2 can no longer consist of multiplexers because each of the signals S′1, . . . S′j, . . . S′p that they must combine is a wavelength division multiplex.

There is claimed:

1. A wavelength selector and converter device for n spectral components of a wavelength division multiplexed input signal, said n spectral components being identified by n respective input carrier wavelengths, which device includes:
demultiplexer and broadcaster means for sampling from said input signal p parts of each spectral component and thereby forming n.p spatially separated extracted signals,
associated with each spectral component, p wavelength converter devices receiving p respective signals extracted from said associated spectral component and adapted to supply p converted signals as a function of said p respective extracted signals, said p converted signals being conveyed by p respective output wavelengths with different predetermined values, each converter device having an optical gate function, and
output coupler means adapted to couple said outputs of said wavelength converter devices to a common output port.

2. The device claimed in claim 1 wherein said demultiplexer and broadcaster means include:
an input coupler adapted to supply on p outputs p parts of said input signal, and
p input demultiplexers each having an input and n outputs, said inputs of said input demultiplexers being coupled to respective outputs of said input coupler, and each of said input demultiplexers being adapted to supply at its outputs n signals extracted from said n respective spectral components.

3. The device claimed in claim 1 wherein said demultiplexer and broadcaster means include:
an input demultiplexer adapted to supply at n outputs said n spectral components of said input signal, and
n input couplers each having an input and p outputs, said inputs of said input couplers being coupled to respective outputs of said input demultiplexer.

4. The device claimed in claim 1 wherein said output coupler means include:
p output couplers associated with said respective output wavelengths and each having an output and n inputs adapted to receive respective converted signals conveyed by said associated output wavelength, and
an output multiplexer having an output and p inputs set to said p respective output wavelengths and coupled to respective outputs of respective output couplers associated with said output wavelengths.

5. The device claimed in claim 1 wherein said output coupler means include:
n output multiplexers each having an output and p inputs set to said p respective output wavelengths and adapted to receive respective converted signals conveyed by said respective output wavelengths, and
an output coupler having an output and n inputs coupled to respective outputs of said output multiplexers.

6. The device claimed in claim 1 wherein each wavelength converter device includes a semiconductor optical amplifier used as an optical gate and receiving one of said extracted signals and a probe wave having one of said particular wavelengths, a converted signal consisting of said probe wave amplified by said amplifier with a gain that is a function of the optical power of said extracted signal that it receives.

7. The device claimed in claim 6 wherein each has a maximum gain at the wavelength of the extracted signal that it receives.

8. The device claimed in claim 6 wherein said probe wave and said extracted signal injected into said amplifier have opposite propagation directions.

9. The device claimed in claim 6 wherein said optical gate function of said amplifiers is obtained by selective application of power supply voltages to said amplifiers.

10. The device claimed in claim 6 wherein said optical gate function of said amplifiers is obtained by selectively injecting said probe waves into said amplifiers.

11. A photonic switching matrix including, coupled in cascade, at least one set of delay lines, a space switch, at least one spectral selector stage and at least one spectral reallocator stage, wherein said spectral selector stage or stages and said spectral reallocator stage or stages include wavelength selector and converter devices as claimed in any of claims 1 to 10.
